(19) United States
(12) Patent Application Publication
(10) Pub. No.: US 2015/0153190 A1
(43) Pub. Date: Jun. 4, 2015

(54) METHOD OF SETTING TRANSIT POINT OF NAVIGATION

(71) Applicant: Hyundai Motor Company, Seoul (KR)

(72) Inventor: Dae Ro PARK, Hwaseong-si (KR)

(73) Assignee: Hyundai Motor Company

(21) Appl. No.: 14/333,114

(22) Filed: Jul. 16, 2014

(30) Foreign Application Priority Data
Dec. 2, 2013 (KR) 10-2013-0148415

(51) Int. Cl. G01C 21/34

(52) U.S. Cl. CPC G01C 21/34

(57) ABSTRACT

A method of setting a transit point of navigation includes inputting a plurality of destinations including a destination of a driver and a destination of a passenger. A route for a starting point, a transit point, and the destination of the driver are sought when the transit point is set as the destination of the passenger. An optimal transit point for giving consideration to the passenger is calculated on a driving route from the starting point to the destination of the driver by inputting various traffic information about the passenger when the transit point is not set as the destination of the passenger.

### CROSS-REFERENCE TO RELATED APPLICATION

This application claims under 35 U.S.C. §119(a) the benefit of priority to Korean Patent Application No. 10-201 3-01 4841 5 filed on Dec. 2, 2013, the entire contents of which are incorporated herein by reference.

### TECHNICAL FIELD

The present disclosure relates to a method of setting a transit point of navigation. More particularly, the present disclosure relates to a method of setting a transit point of navigation capable of calculating an optimal transit point at which a passenger gets out of a vehicle when destinations of a driver is different from that of the passenger.

### BACKGROUND

As well known in the related art, a navigator for a vehicle and a portal site for serving map information have provided consumers or users with an optimal route for travel when a starting point, a transit point (option), and a destination are input thereto.

As shown in FIG. 1, when a starting point, a transit point (option), and a destination are input, a plurality of recommended routes are presented based on traffic, road, and map information available and a driver or user selects one of the routes to drive a vehicle. Passengers get off occasionally when traveling together with the vehicle having a navigator.

As shown on a driving route denoted on a map of FIG. 5A, the driver may take the passenger to his/her final destination, however, when the destination of the driver is far from that of the passenger, it may be necessary to set an optimal transit point considering the passenger. In the case of setting a third transit point, that is, the optimal transit point to be considerate of the passenger, although the driver seeks the optimal transit point utilizing the map and traffic information or public transportation and convenience of the passenger, since a navigation system cannot add information favored by the passenger to various kinds of information, it is difficult to find the optimal transit point for the passenger.

In addition, when the optimal transit point for the destination of the passenger is not found, the passenger may get off far from the destination of the passenger, and there may be no public transportation available for the passenger to arrive at the final destination, thus incurring various inconveniences.

To improve the inconvenience, a method of setting a transit point is required according to a new intelligent transport system (ITS) utilizing various kinds of information.

### SUMMARY OF THE DISCLOSURE

The present disclosure provides a method of setting a transit point of navigation which can seek an optimal transit point, by which a passenger conveniently arrives at his/her destination in a short time, on a driving route from a starting point to a destination of a driver by simultaneously inputting favored traffic information, the destination of the driver and the passenger, and the starting point, so that the optimal transit point is set to consider the destination of the passenger.

According to an exemplary embodiment of present disclosure, a method of setting a transit point of navigation includes inputting a plurality of destinations including a destination of a driver and a destination of a passenger. A route for a starting point, a transit point, and the destination of the driver are sought when the transit point is set as the destination of the passenger. An optimal transit point for giving consideration to the passenger on a driving route from the starting point to the destination of the driver is calculated by inputting various kinds of traffic information about the passenger when the transit point is not set as the destination of the passenger.

The step of calculating the optimal transit point includes inputting the favored traffic information including a favorite transportation means for the destination of the passenger, the transfer number of the transportation means, and a radius of the destination of the driver to the transit point of the passenger. The route from the starting point to the destination of the driver is sought Information about the transportation means in the driving route from the starting point to the destination of the driver is obtained. The optimal transit point for the passenger is inquired and selected by comparing the obtained transportation information and the input favored traffic information of the passenger.

The step of inquiring and selecting the optimal transit point may select a location at which transportation means information, which is matched with the favorite transportation means and the transfer number of transportation means to the destination of the passenger within the radius from the destination of the driver to the transit point of the passenger, exists as the optimal transit point.

The method may further include, after the step of calculating the optimal transit point, when it is determined that the calculated optimal transit point is suited, displaying the driving route including the optimal transit point after displaying the favorite transportation means, the transfer information, and a location of the optimal transit point on a display.

The method may further include re-displaying the favorite transportation means and the transfer information for the passenger when arriving at the optimal transit point on the display.

The method may further include, when it is determined that the calculated optimal transit point is not suited after the step of calculating the optimal transit point, displaying the driving route including the optimal transit point after displaying the favorite transportation means, transfer information, and the optimal transit point on a display.

The method further includes, when the passenger is not satisfied with the optimal transit point and the favored traffic information of the passenger is re-input, calculating another transit point for the passenger.

According to the present disclosure, destinations of a driver and a passenger are input together with a starting point and simultaneously, traffic information, which the passenger uses to arrive at a destination, is input, so that an optimal transit point, by which the passenger conveniently arrives at his/her destination for a short time in a driving route from the starting point to the destination of the driver, is provided to guide the passenger to the destination.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure.

FIG. 1 is a concept view showing an example of calculating a route of navigation according to the related art.

FIG. 2 is a concept view illustrating a method of setting a transit point of navigation according to the present disclosure.

FIGS. 3 and 4 are flowcharts illustrating a method of setting a transit point of navigation according to the present disclosure.

FIG. 5a shows a navigation screen on which a passenger's destination is set as a transit point according to the related art.

FIG. 5b shows a navigation screen on which a passenger's destination is set as an optimal transit point for taking a passenger into consideration according to the present disclosure.

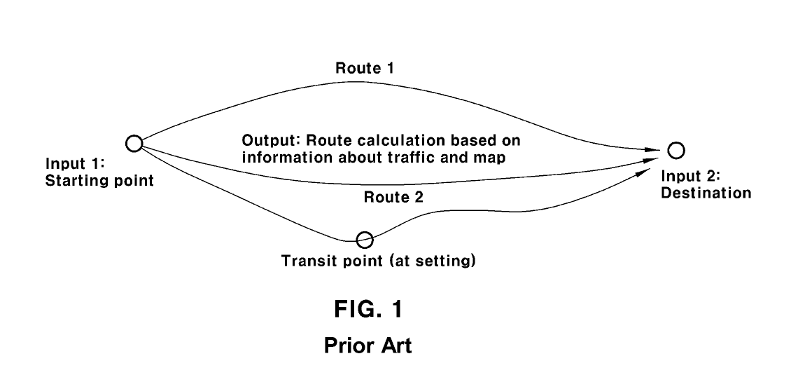

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

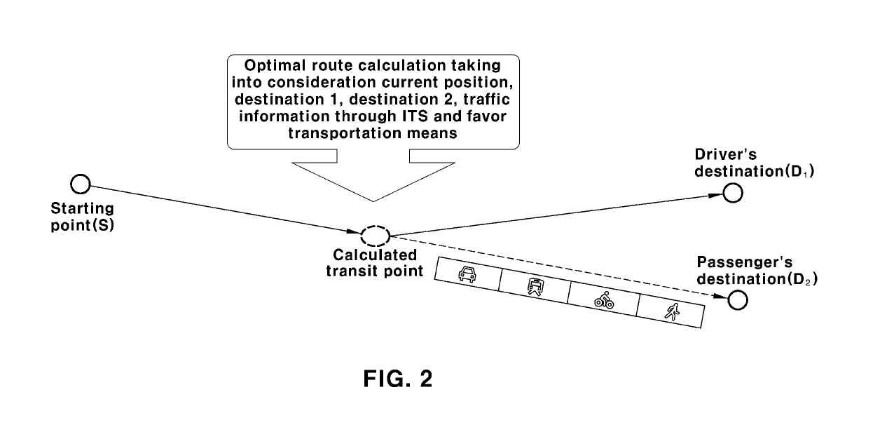

As shown in FIG. 2, the present disclosure illustrates a method of finding an optimal transit point, by which a passenger conveniently arrives within a short time from a starting point to a destination of a driver, by inputting favored traffic information which the passenger uses to arrive at a destination as well as the destinations of the driver and the passenger are input together with the starting point.

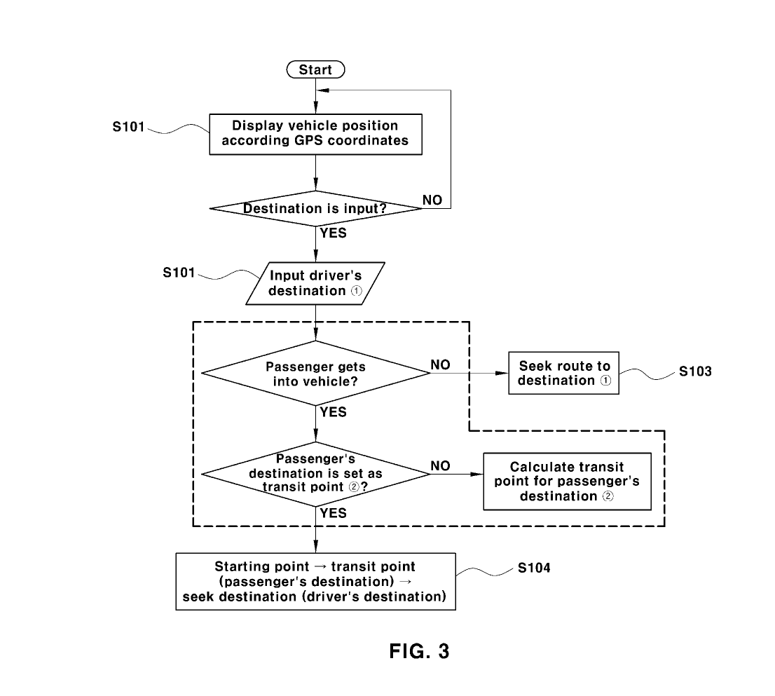

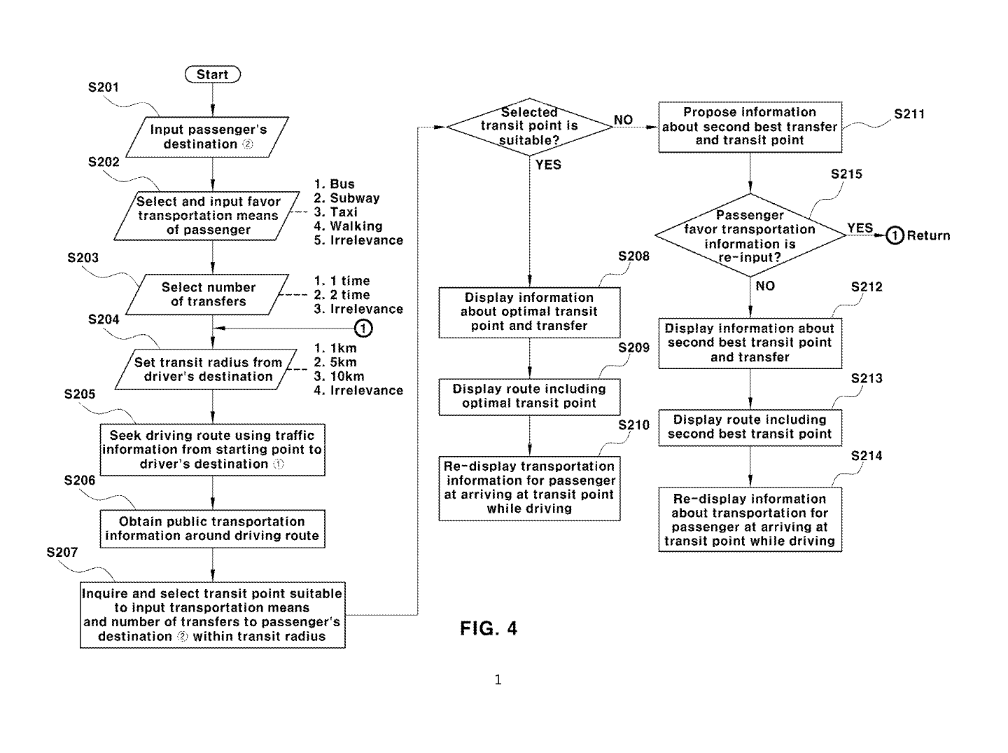

FIGS. 3 and 4 are flowcharts illustrating a method of setting a navigation transit point according to the present disclosure.

Referring to FIG. 3, when a navigation system starts, and a vehicle position is displayed on a display of a global positioning system (GPS) in step S101, a driver inputs his/her destination into the navigation system in step S102. If there is no passenger in the vehicle, a driving route to the driver's destination input by the driver is sought in step S103. When there is a passenger in the vehicle, and a destination of the passenger is input, the passenger's destination is set as a transit point, a driving route of “starting point→transit point (passenger's destination)→destination (driver's destination)” is sought in step S104.

Even though the destination of the driver is far away from that of the passenger, an optimal transit point is set taking the passenger into consideration. That is, the third transit point as the optimal transit point is set on the driving route from the starting point to the driver's destination in consideration of the passenger, so that the optimal transit point, by which the passenger conveniently arrives at the passenger's destination within a short time, is guided on the driving route from the starting point to the driver's destination.

The method of calculating the optimal transit point to the passenger's destination will be described as follows.

When various traffic information of the passenger is input, the optimal transit point, which is set on the driving route from the starting point to the driver's destination in consideration of the passenger, is calculated.

Referring to FIG. 4, a plurality of destinations including the destinations of the driver and the passenger are input to the navigator in step S201, and the optimal transit point is calculated by inputting the various traffic information of the passenger. The step of inputting the various traffic information of the passenger includes inputting transportation means for the passenger's destination (S202), inputting the transfer number of transportation means (S203), and inputting a radius (area selectable as the optimal transit point) of the driver's destination to a passenger's transit point (S204).

For example, the favorite transportation means may be classified and input as one of bus, subway, taxi, walking, irrelevance items, and the like, and the transfer number of transportation means may be classified and input as one of once, twice, irrelevance, etc. In addition, the transit point radius may be classified and input as one of “1 km”, “5 km,” irrelevance, etc.

The driving route is sought by using the traffic information between the starting point and the driver's destination in step S205, and the vehicle is driven along the driving route sought therefrom. Next, information about the transportation means on the driving route from the starting point to the driver's destination or within the radius of the passenger's transit point from the driver's destination is performed in step S206. For reference, the navigation system may obtain the traffic and transportation means information from an external server through a telematics system.

Then, by comparing the obtained information about the transportation means with the previous input traffic information of the passenger to determine whether matching information exists, the optimal transit point for the passenger is sought or selected (S207). During the step of seeking or selecting the optimal transit point for the passenger, it is determined whether the transportation means information matched with the favorite transportation means and the transfer number exist within the radius of the passenger transit point from the previously input driver's destination. Then, a position, at which the transportation means information matched with the transportation means and the transfer number exist, is selected as the optimal transit point.

For example, when the passenger inputs “subway” as the favorite transportation means, “once” as the transfer number, and “irrelevance” as the transit point radius, after determining whether the input transportation means information exists in the obtained transportation means information, the position, in which the transportation means information matched with the favorite transportation means and the transfer number exists, is selected as the optimal transit point.

When it is determined that the optimal transit point selected above is suitable, that is, satisfied as the transit port matched with the transportation means and the transfer number desired by the passenger, the information about the favorite transportation means and the transfer number in addition to the position of the optimal transit point is displayed on the display in step S208, and then, the driving route including the optimal transit point is displayed in step S209.

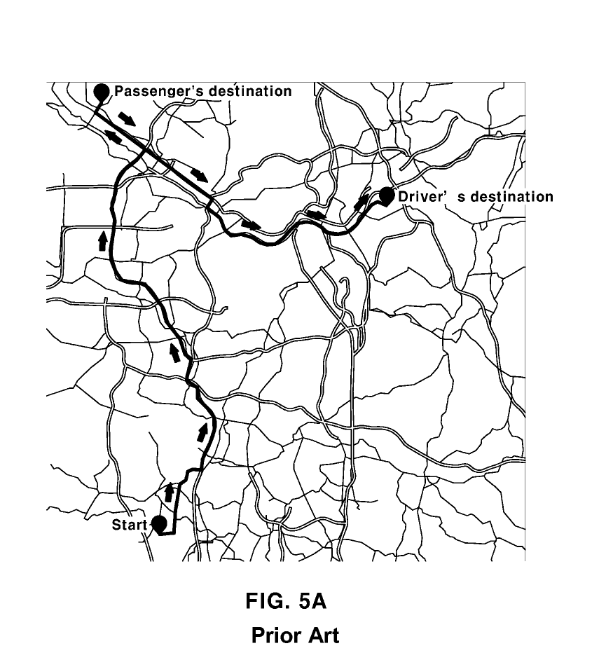

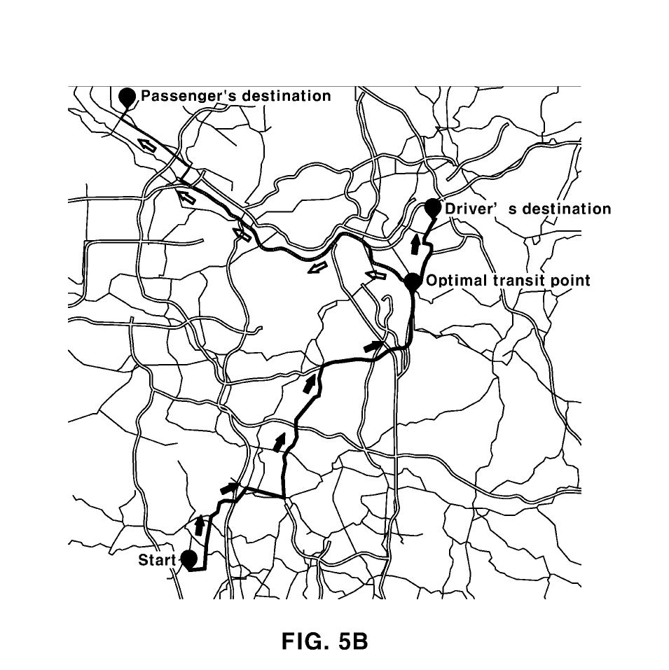

As an example depicted in FIG. 5B, the driving route from the starting point to the driver's destination and the optimal transit point from which the passenger may arrive at the passenger's destination is displayed. Thus, the driver drives toward the optimal transit point, and as soon as the vehicle arrives at the optimal transit point, the information about the transportation means and the transfer number is re-displayed in step S210. Therefore, the passenger can recognize the information about the transportation means at the optimal transit point again.

When it is determined that the selected optimal transit point is not suitable, that is, the passenger is not satisfied with any of the transportation means and the transfer number, the information about the favorite transportation means and transfer in addition to the second transit point (as the second best), which exists on the second best transit point, is displayed in step S211. Then, when the passenger is satisfied with the second best transit point, after continuously displaying the information about the transportation means and transfer which exists at the second transit point in step S212, the driving route including the second best transit point is displayed on the display in step S213. Thus, the driver drives toward the selected second transit port. The information about the favorite transportation means and transfer may be redisplayed when arriving at the second transit point in step S214, so that the passenger recognizes the information about the transportation means of the second transit point at the optimal transit point again.

When the passenger is not satisfied with the second best transit point, as described above, step S215 of re-inputting the traffic information favored by the passenger is performed, so that the step of calculating another transit point for the passenger can be repeated in the same manner as described above. Thus, the destinations of the driver and the passenger are input together with the starting point and simultaneously, the favored traffic information, which the passenger uses to arrive at the destination, is input, so that the optimal transit point, by which the passenger conveniently arrives at his/her destination in a short time on the driving route from the starting point to the destination of the driver, is provided to guide the passenger to his/her destination.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of setting a transit point of navigation, the method comprising steps of:
inputting a plurality of destinations including a destination of a driver and a destination of a passenger;
seeking a route for a starting point, a transit point, and the destination of the driver when the transit point is set as the destination of the passenger; and
calculating an optimal transit point for giving consideration to the passenger on a driving route from the starting point to the destination of the driver by inputting various traffic information favored by the passenger when the transit point is not set as the destination of the passenger.

2. The method of claim 1, wherein the calculating of the optimal transit point includes steps of:
inputting the favored traffic information including a favorite transportation means for the destination of the passenger, the transfer number of the favorite transportation means and a radius of the destination of the driver to the transit point of the passenger;
seeking the route from the starting point to the destination of the driver;
obtaining information about the favorite transportation means in the driving route from the starting point to the destination of the driver; and
inquiring and selecting the optimal transit point for the passenger by comparing the obtained transportation information and the input the traffic information favored by the passenger.

3. The method of claim 2, wherein the step of inquiring and selecting the optimal transit point selects a location at which the transportation means information, which is matched with the favorite transportation means and the transfer number of transportation means to the destination of the passenger in the radius from the destination of the driver to the transit point of the passenger, exists as the optimal transit point.

4. The method of claim 1, further comprising:
after the step of calculating the optimal transit point, when it is determined that the calculated optimal transit point is suited, displaying the driving route including the optimal transit point after displaying the favorite transportation means, transfer information, and a location of the optimal transit point on a display.

5. The method of claim 4, further comprising:
re-displaying the favorite transportation means and the transfer information for the passenger at a moment of arriving at the optimal transit point on the display.

6. The method of claim 1, further comprising:
when it is determined that the calculated optimal transit point is not suited after the step of calculating the optimal transit point, displaying the driving route including the optimal transit point after displaying the favorite transportation means, transfer information and the optimal transit point on a display.

7. The method of claim 6, further comprising:
when the passenger is not satisfied with the optimal transit point and the traffic information favored by the passenger is re-input, calculating another transit point for the passenger.
